(19) United States
(12) Patent Application Publication
(10) Pub. No.: US 2010/0083300 A1
(43) Pub. Date: Apr. 1, 2010

(54) LICENSE UPDATE METHOD AND APPARATUS FOR RIGHT-PROTECTED BROADCAST CHANNEL

(75) Inventors: Hak Sung Lyou, Gyeongsangbuk-do (KR); Ho Kwon Song, Seoul (KR); Jeong Wook Seo, Deagu Metropolitan City (KR); Eun Jung Seo, Gyeongsangbuk-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/560,631

(22) Filed: Sep. 16, 2009

(30) Foreign Application Priority Data
Sep. 26, 2008 (KR) 2008-94841

(51) Int. Cl. H04N 7/16; G06F 21/00; H04N 5/445

(52) U.S. Cl. 725/27; 726/26; 348/563; 725/31

(57) ABSTRACT

A license update method and apparatus for a right-protected broadcast channel prevents interruption of the ongoing playback of the right-protected broadcast channel due to the expiration of the license without the user's awareness by controlling the license update timing before the expiration of the license. The license update method according to the present invention includes setting a timer; detecting an expiration time of the timer; and updating a short-term license having a periodic duration which is updated with a periodicity within an entire license duration for the right-protected broadcast channel at the expiration time of the timer.

### CLAIM OF PRIORITY

This application claims priority from an application entitled “LICENSE UPDATE METHOD AND APPARATUS FOR RIGHT-PROTECTED BROADCAST CHANNEL” filed in the Korean Intellectual Property Office on Sep. 26, 2008 and assigned Serial No. 10-2008-0094841, the contents of which are incorporated herein by reference in its entirety.

### BACKGROUND OF THE INVENTION

1. Field of the Invention

The present invention relates to a digital broadcast service and, in particular, to a license update method and apparatus for a right-protected broadcast channel and to the expiration of a license to playback the broadcast channel.

2. Description of the Related Art

Digital broadcast receiver enables automatic and manual tuning to frequencies carrying digital broadcast signals. Typically, the digital broadcast signals are digitally encoded and modulated, and thus the broadcast receiver should be capable of demodulating and decoding the received broadcast signals. In order to receive and process the coded and modulated digital broadcast signals, a digital broadcast receiver includes a tuner, a broadcast data demodulator, and a broadcast data decoder. Recent digital broadcast systems are classified into a digital multimedia broadcast (DMB) system and a digital video broadcasting (DVB) system. These digital broadcast systems provide a plurality of service channels in a given frequency bandwidth, and each service channel carries broadcast program data and program information.

In the case of DVB-Handheld (DVB-H) system, a service channel is multiplexed with audio/video data and supplementary program information. The audio/video data are transported using Real Time Transport (RTP) protocol, and the program information is transported using FLUTE protocol. The FLUTE protocol is built on top of (i.e. runs on) Asynchronous Layered Coding (ALC) protocol combining Layered Coding Transport (LCT) protocol, and FLUTE packets carry a File Delivery Table (FDT) and Object Data.

In the meantime, a DVB-H digital broadcast receiver can be configured to support a Digital Rights Management (DRM) for billing to a specific broadcast channel. In this case, the broadcast of the channel is provided to the subscribers having the right to use specific contents. The DRM can be implemented in various right restriction ways, e.g. duration restriction and playback number restriction. With the widespread use of the mobile terminals and expectation of increase of the broadcast-enabled mobile terminals, there is a need to develop a right protection method appropriate for the DVB-H service and efficiently managing the license issued for the right-protected broadcast channel.

### SUMMARY OF THE INVENTION

Accordingly, the present invention provides a right protection policy that is well-suited for the digital broadcast channel and a license update method and apparatus for a right-protected broadcast channel that advantageously prevents the ongoing playback of the broadcast data from being interrupted due to the expiration of the license without user's awareness.

In accordance with an exemplary embodiment of the present invention, a license update method of a digital broadcast receiver for a right-protected broadcast channel preferably includes setting a timer; detecting an expiration time of the timer; and updating a short term license having a periodic duration which is updated with a periodicity within an entire license duration for the right-protected broadcast channel at the expiration time of the timer.

In accordance with another exemplary embodiment of the present invention, a license update apparatus of a digital broadcast receiver for a right-protected broadcast channel preferably includes a control unit which updates a short-term license having a periodic duration updated with a periodicity within an entire license duration for the right-protected broadcast channel at an expiration time of a timer; a storage unit for storing the short-term license and for storing an updated short-term license stored previously, and/or storing a new short-term license under the control of the control unit; a broadcast reception unit which decodes broadcast data on the right-protected broadcast channel by using the short-term license; and a display unit which output the broadcast data decoded by the broadcast reception unit.

### BRIEF DESCRIPTION OF THE DRAWINGS

The above features and advantages of the present invention will become more apparent from the following detailed description in conjunction with the accompanying drawings, in which:

FIG. 1 is a schematic diagram illustrating a license update system according to an exemplary embodiment of the present invention;

FIG. 2 is a block diagram illustrating a configuration of the digital broadcast receiver according to an exemplary embodiment of the present invention;

FIG. 3 is a block diagram illustrating a configuration of the broadcast reception unit of FIG. 2;

FIG. 4 is a flowchart illustrating exemplary operation of a license update method for a right-protected broadcast channel according to a preferred exemplary embodiment of the present invention; and

FIG. 5 is a flowchart illustrating exemplary operation of a timer setting process of the license update method according to an exemplary embodiment of the present invention.

### DETAILED DESCRIPTION

Exemplary embodiments of the present invention are described with reference to the accompanying drawings in detail for explanatory purposes to a person of ordinary skill in the art. The same reference numbers are used throughout the drawings to refer to the same or like parts. Detailed descriptions of well-known functions and structures incorporated herein may be omitted to avoid obscuring appreciation by an artisan of the subject matter of the present invention.

The terms and words used in this specification and claims shall not be understood as limited to the lexical meaning. Based on the principle that an inventor can adequately define terms to best describe his/her invention, the terms and words shall be interpreted as conforming to the technical spirit of the present invention. Accordingly, the examples and drawings disclosed in the specification are only exemplary and do not limit the claimed invention thereto, and there may be various equivalents and modifications within the spirit of the invention and the scope of the appended claims.

Although the license method and apparatus is described in association with a DVB-H digital broadcast receiver in the following description, the present invention is not limited thereto. For instance, the license update method and apparatus of the present invention is applicable to other broadcast standard-based broadcast receivers and broadcast-enabled mobile terminals supporting DRM, or any system operating in a similar fashion as DRM.

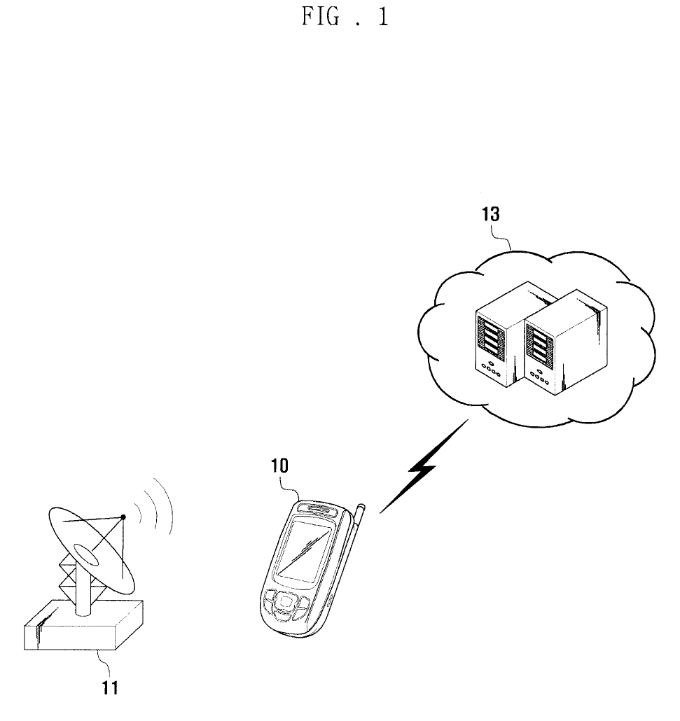

FIG. 1 is a schematic diagram illustrating a license update system according to an exemplary embodiment of the present invention.

Referring to FIG. 1, the license update system includes a broadcast station 11, a digital broadcast receiver 10, and a broadcast server 13. The broadcast server 130 is configured to issue a child license (i.e. short-term license) for a broadcast channel which is DRM-protected by a parent license (long-term license) or include a rights issuer server for issuing the short-term license.

In the license update system described above and shown by example in FIG. 1, the digital broadcast receiver 10 stores a short-term license issued by the broadcast server 13, checks the expiration of the short term license while decoding the broadcast signal received on the broadcast channel by using the short-term license, and updates the short term license, or replaces the short-term license with a new one, at a time before the expiration of the short-term license. Here, the short-term license may comprise a child license corresponding to a periodic duration of the entire duration permitted by the long-term license as the parent license. For instance, when the user purchases a long term license permitting use of a right-protected broadcast channel during a given license duration (e.g. 1 year), the broadcast server 13 issues a short-term license for a periodic duration with a periodicity requested by the user before expiration of the license duration such that the digital broadcast receiver 10 can decode the data on the right-protected broadcast channel using the short-term license.

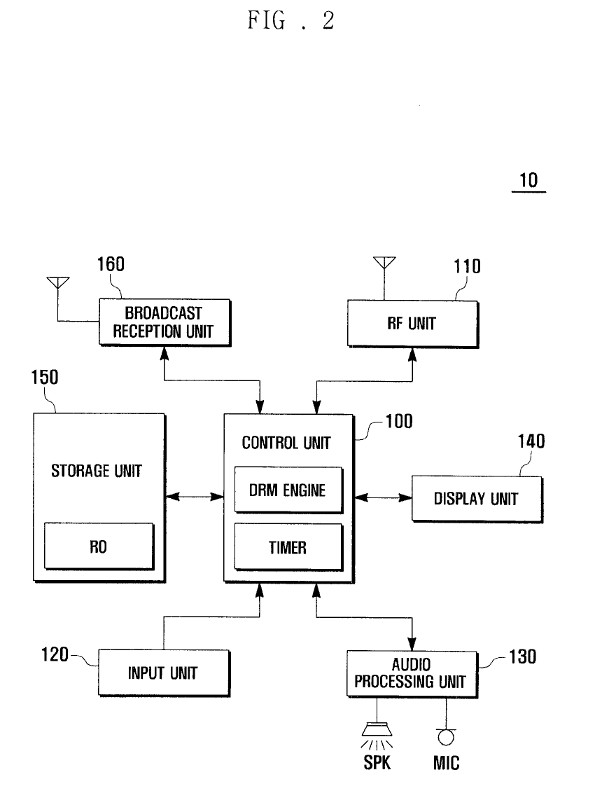

The internal structures of the exemplary digital broadcast receiver 10 are described hereinafter in detail with reference to FIG. 2.

FIG. 2 is a block diagram illustrating a preferred configuration of the digital broadcast receiver according to an exemplary embodiment of the present invention.

Referring now to FIG. 2, the digital broadcast receiver 10 includes a Radio Frequency (RF) unit 110, an input unit 120, an audio processing unit 130, a display unit 140, a storage unit 150, a broadcast reception unit 160, and a control unit 100.

The digital broadcast receiver 10 receives the broadcast signals via the broadcast reception unit 160 and decodes the broadcast data on the broadcast channel for which a short-term license (also referred to as a Right Object, or “RO”) is acquired. That is, once a short-term license for a specific broadcast channel is issued to the digital broadcast receiver 10 by the broadcast server 13, the digital broadcast receiver 10 decodes the broadcast signal received on the corresponding broadcast channel by using the short-term license such that the video and audio data decoded from the broadcast data are output by the respective display unit 140 and the audio processing unit 130. At this time, the digital broadcast receiver 10 checks the validity of the short-term license stored in the storage unit 150 and, if the short term license is valid, decodes the broadcast data received on the broadcast channel. In a case in which the short-term license is invalid, the digital broadcast receiver 10 accesses the broadcast server 13 and downloads a new short-term license from the broadcast server. In order to prevent the ongoing broadcast stream from being interrupted due to the expiration of the short term license, the digital broadcast receiver 10 checks the validity of the short term license stored in the storage unit 150 in response to a user command input through the input unit 120, starts a timer set to output an alert at a time before the expiration date/time/count of the short-term license, and accesses the broadcast server 13 and downloads a new short-term license in response the alert or a user request, whereby the digital broadcast receiver 10 can update the short-term license to maintain the validity of the license for the right-protected broadcast channel. The operations of the internal function blocks of the digital broadcast receiver 10 are described hereinafter in more detail.

The RF unit 110 transmits and receives radio signals carrying voice, video and/or data communications. The RF unit 110 is provided when the digital broadcast receiver 10 supports a wirelessly transmitted communication function, typically at RF frequencies. The RF unit 110 is provided with an RF transmitter for up-converting and amplifying the transmission signal frequency and an RF receiver for low noise amplifying and down-converting the received signal frequency.

In particular, in an exemplary embodiment of the present invention, the RF unit 110 establishes a communication link with the broadcast server 13 (see FIG. 1) by issuing the short-term license which allows permitting playback of the broadcast data on the DRM-protected channel. That is, the RF unit 110 establishes a communication channel to access the broadcast server 13 at a predetermined time and request the broadcast server 13 to send a short-term license under the control of the control unit 100. The short-term license acquired from the broadcast server 13 is delivered to the control unit 100. Although it is described that the digital broadcast receiver 10 accesses the broadcast server 13 via the RF unit 110 in consideration of its mobility, the present invention is not limited thereto. For instance, the digital broadcast receiver 10 may further include a wire modem for establishing a wired connection to the broadcast server 13, or the RF unit 110 can be replaced by the wire mode.

Still referring to FIG. 2, the input unit 120 is provided with a plurality of alphanumeric keys for receiving alphabetic and numeric data input by the user and a plurality of function keys for setting and executing various functions of the digital broadcast receiver 10. The function keys can be implemented in the forms of navigation keys, side keys, and shortcut keys. The input unit 120 can generate input signals for activating the broadcast reception unit 160, scanning broadcast channels, and selecting one of scanned broadcast channels in response to the user's key inputs, and outputs the input signals to the control unit 100. The input unit 120 also can be configured such that the user is able to enter the time (including date) for updating the short-term license (RO).

The audio processing unit 130 processes the audio data extracted from the broadcast data and outputs the audio data through a speaker (SPK) in the form of an audible sound wave. In a case where the digital broadcast receiver 10 supports the cellular communication function, the audio processing unit 130 further includes a microphone (MIC) for receiving the audio signal including voice.

The display unit 140 displays various operational status screens of the digital broadcast receiver 10. For instance, the display unit 140 can display a booting progress screen, an idle mode screen, menu screens, and broadcast application screen. The display unit 140 can be implemented with a Liquid Crystal Display (LCD) panel, as just one possible example, and other thin-film technology screens can be used. In the case of an LCD panel, the display unit 140 preferably includes an LCD controller, a video memory for buffering video data, and LCD devices. When the LCD supports a touchscreen function, the display unit 140 can operate as a part of (or in place of) the input unit 120.

More particularly, in an exemplary embodiment of the present invention, the display unit 140 is configured to display the menu screen presenting items or icons related to the broadcast reception unit 160, a channel list screen for displaying the broadcast channels scanned with the activation of the broadcast reception unit 160, and a broadcast data playback screen on which the decoded video data are displayed in the form of a visual image. When a DRM-protected broadcast channel is selected, the broadcast data received on the broadcast channel may or may not be decoded depending on whether a short-term license for the DRM-protected broadcast channel is stored in the storage unit 150. The display unit 140 also can be configured to output the alert triggered by the expiration of the timer and a popup window having an input box for the user to set the timer defining the short-term license update time.

Still referring to FIG. 2, the storage unit 150 stores application programs related to the functions and operations of the digital broadcast receiver 10 such as a digital broadcast reception application, a license management application for requesting the server to send a short-term license, and a DRM engine for supporting short-term license-based contents protection. The storage unit 150 can be configured to buffer the broadcast data received via the broadcast reception unit 160 in unit of a predetermined data block. The storage unit 150 can be divided into a program region and a data region, as discussed hereinbelow.

The program region is preferably allocated for storing an Operating System (OS) for booting up the digital broadcast receiver 10 and an application program for controlling the operations of the broadcast reception unit 160, an application program for controlling the RF unit 110 to acquire the short-term license, a DRM engine for supporting the short term license-based contents protection, and an short-term license update application. The program region may also be used for storing the applications for supporting other supplementary functions of the digital broadcast receiver 10 such as camera function, audio playback function, as well as still picture and motion picture playback functions. The short term license update application includes a routine for checking the expiration of the short-term license stored in the storage unit 150 and starting a timer based on the expiration of the short-term license and a routine for controlling the internal function blocks to update the short term license at the expiration of the timer. The short term license update application can further include a routine for displaying the popup window to allow the user to set the expiration of the short-term license as the expiration of the timer and a routine for the user to modify the expiration of the timer via the input unit 120. The short-term license update application may additionally include a popup window control routine for configuring the timer to operate according to the update time point set by the user, a timer operation control routine for operating the time as set by the user, and a routing procedure for updating the short-term license at the expiration of the timer.

The data region stores: (1) application data generated while the digital broadcast receiver 10 is running with the application programs; (2) temporary data generated while receiving the broadcast data; and (3) program information related to programs carried on the broadcast channels such as Electric Service Guide (ESG) and Electric Program Guide (EPG). The data region also stores the short-term licenses. In case that a short-term license update application program is running in the digital broadcast receiver 10, each short-term license is updated with a newly received short-term license under the control of the control unit 100.

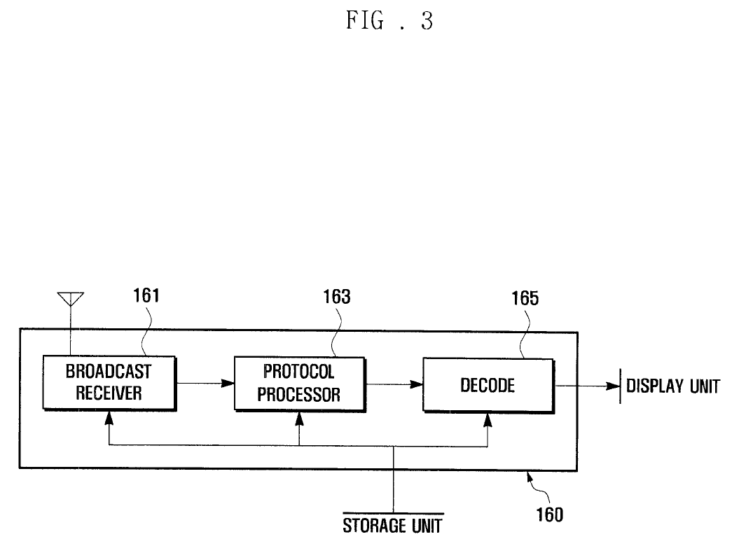

The broadcast reception unit 160 receives the broadcast signals transmitted by the broadcast station 11 and discriminates and processes the received broadcast signals according to corresponding processing procedures. That is, the broadcast reception unit 160 identifies the broadcast signals including program guide channel, receives the broadcast signals transmitted over the broadcast channel(s) with reference to the program guide obtained from the program guide channel, and outputs to the control unit 100 the broadcast data obtained from the broadcast signals. The broadcast reception unit 160 can be composed of a broadcast receiver 161, a protocol processor 163, and a decoder 165, as shown in FIG. 3.

Now referring to FIG. 3, the broadcast receiver 161 of FIG. 2 receives broadcast data on the broadcast channels selected by the user under the control of the control unit 100. The protocol processor 163 performs protocol processing of the broadcast data of the broadcast channels so as to extract video data, audio data, and supplementary broadcast information (e.g. program guide). The decoder 165 includes an audio decoder, a video decoder, and a data processor. The audio decoder decodes the audio data extracted from the broadcast data. The video decoder decodes the video data extracted from the broadcast data. The decoded video and audio data are output through the display unit 140 and the speaker (SPK), respectively. The data processor decodes the supplementary broadcast information and, if required, updates the supplementary broadcast information.

The control unit 100 controls the power supply to internal function blocks of the digital broadcast receiver 10 and signaling among the internal function blocks. Particularly in an exemplary embodiment, the control unit 100 activates the broadcast reception unit 10 in response to a user input, and also checks whether the broadcast channel selected by the user is DRM-protected. If the selected broadcast channel is DRM-protected, the control unit 100 retrieves the short-term license for the DRM-protected broadcast channel and checks the validity of the short-term license. If it is determined that the short-term license is valid, the control unit 100 decodes the broadcast data on the selected broadcast channel by using the short-term license such that the video and audio data extracted from the broadcast data are output through the display unit 140 and the speaker (SPK), respectively. Here, the short term license can be a child license corresponding to a periodic duration/portion of the entire duration permitted by a long-term license as the parent license. For instance, the long-term license may comprise, for example, a 1-year license for a broadcast channel of MBC, and the short-term license can be a license having a license duration which is updated with a periodicity within the entire license duration of 1 year. The short-term license is issued by a broadcast server of the MBC periodically when the user has purchased the long-term license such that the digital broadcast receiver 10 downloads the short-term license from the broadcast server and stores the downloaded short-term license within the storage unit 150. The purpose using a short-term license in addition to the long term license and updating the short-term license periodically is to enhance security and protection of channel access right. Since the short-term license is updated at a predetermined time, for example, every day or at a certain date of every month, it is possible to improve the security of the license for a right-protected broadcast channel. In an exemplary case of monthly update policy in which the short-term license is updated on the first day of every month, the digital broadcast receiver 10 should preferably download a new short-term license from the broadcast server 13 on the first day of every month for normally accessing the corresponding broadcast channel. Accordingly, there can be a break of the broadcast stream in the middle of the short term license renewal process on the first day of every month due to the processing delay caused by checking the validity of the short-term license, downloading a new short-term license, and verifying the downloaded short-term license. In order to avoid the ongoing broadcast stream from being interrupted due to the short-term license update process, the control unit 100 of the digital broadcast receiver 10 checks the validity of the short-term license at predetermined time interval (in this case, preferably checks every hour) and, if the expiration of the short-term license is expected in a predetermined time, accesses the broadcast server 13 and downloads a new short-term license from the broadcast server 13 in background processing mode and/or in multi-processing mode when other applications are running.

For instance, assuming the user intends to set the license update time to 2 A.M., the control unit 100 of the digital broadcast receiver 10 controls the display unit 140 to display a timer configuration popup window is displayed such that the user to set the license update time to 2 A.M. through the timer configuration popup window. Once the timer is set, the control unit 100 controls such that the RF unit 100 is activated to establish a communication channel with the broadcast server 13 and downloads a new short-term license from the broadcast server 13 to update the short-term license previously stored in the storage unit 150. At this time, the broadcast server 13 issues a short-term license having the license duration starting from the date of the access of the digital broadcast receiver 10 and sends the issued short-term license to the digital broadcast receiver 10. Assuming that the user has purchased a long-term license having the license duration of 31 days starting from August 30 and ending on September 30 and set the timer to expire at 2:00 A.M. every day, the digital broadcast receiver 10 attempts to access the broadcast server 13 whenever the timer expires and thus the broadcast server 13 can issue the short-term license at 2:00 every day, from August 31, when the access of the digital broadcast receiver 10 is detected. Also, assuming that the user has purchased a long-term license having the license duration of 31 days starting from August 20 and ending on September 30, and set the timer to expire at 2:00 A.M. on every odd numbered date, the broadcast server 13 detects the access of the digital broadcast receiver 10 so as to issue the short-term license at 2:00 A.M. on every odd numbered date when the access of the digital broadcast receiver 10 is detected. Since the broadcast server 13 does not know the value of the timer set at the digital broadcast receiver 10, the broadcast server 13 can be configured to set a periodicity for issuing the short-term license and sends the short-term license with periodicity. Accordingly, it is preferred that the user of the digital broadcast receiver 10 checks the information on the license duration of the short-term license and sets the timer to an appropriate value. In order to facilitate setting the timer, the control unit 100 can be configured to check the expiration time of the short-term license and set the timer with reference to the expiration time of the short-term license automatically when the broadcast reception module is activated to access the broadcast server 13. For instance, assuming that the current time is 8:00 P.M. on August 30 and the expiration time of the short-term license is 8:00 P.M. on September 4, the control unit 100 can set the timer to expire at 8:00 P.M. or 7:00 P.M., for example, on September 4, whereby the control unit 10 activates the RF unit 110, at the 8:00 P.M. or 7:00 P.M. on September 4, to establish a communication channel with the broadcast server 13 and download a new short-term license from for broadcast server 13.

The digital broad receiver 10 also may also be configured, for example, to send the broadcast server 13 the information on the time value set for the timer such that the broadcast server 13 creates the short-term license based on the time value. That is, the digital broadcast receiver 10 sends the broadcast server 13 a time value indicative of 2 days set for the timer, the broadcast server 13 issues the short term license having the license duration of 2 days. In this case, the time value can be set to 48 hours (exactly equal to 2 days) or time duration a little longer than 48 hours such that the two contiguous license durations are overlapped to update the short-term license without interrupting the ongoing playback of the broadcast data.

Furthermore, the control unit 100 obtains the address of the broadcast server 13 from the short-term license stored in the storage unit 150. The control unit 100 controls the digital broadcast receiver 10 to locate and access the broadcast server 13 with reference to the address obtained from the previously stored short-term license. After the digital broadcast receiver 10 connects to the broadcast server 13, the control unit 100 requests the broadcast server 13 to send a new short-term license and stores the new short-term license downloaded from the broadcast server 13. At this time, the control unit 100 sends a short-term license request message including device information on the digital broadcast receiver 10 to the broadcast server 13. Upon receipt of the short-term license request message, the broadcast server 13 identifies the digital broadcast receiver 10 with reference to the device information, checks the long license issued to the digital broadcast receiver 10, and issues a new short-term license in consideration of the long license of the digital broadcast receiver 10. If the new short-term license is received, the control unit 100 of the digital broadcast receiver 10 updates the short-term license by replacing the previously stored short-term license with the new short-term license to maintain the validity of the short-term license.

Upon receipt of the short-term license request message including the device information transmitted by the digital broadcast receiver 10, the broadcast server 13 retrieves the long-term license issued to the digital broadcast receiver 10 identified with the device information. That is, the broadcast server checks the license duration of the long-term license purchased by the user and issues the short-term license in consideration of the remaining duration of the long-term license as well as the periodic duration of the short term license. For instance, assuming that the license duration of the long term license expires September 30, and the digital broadcast receiver 10 requests the broadcast server to send a short-term license, the broadcast server 13 issues the short-term license which expires September 30 even though the periodic duration of the short-term license is 48 hours.

Accordingly, it is preferred that the digital broadcast receiver 10 outputs an alert message asking whether the user wants to repurchase the long-term license, when the duration of the short-term license received from the broadcast server 13 is shorter than the preset periodic duration. The expiration of the long-term license can be reported explicitly. That is, the broadcast server 13 can send the digital broadcast receiver 10 a long-term license purchase solicitation message when the remaining license duration of the long-term license is shorter than the periodic duration of the short term license requested by the digital broadcast receiver. Upon receipt of the long-term license purchase solicitation message, the digital broadcast receiver 10 outputs an alert message asking whether the user wants to repurchase the long term license.

In the aforementioned-discussion, the structure of the digital broadcast receiver 10 discussed were in accordance with updating a short-term license by an apparatus according to the present invention.

Hereinafter, an exemplary licensing update method according to an exemplary embodiment of the present invention will be described with reference to accompanying drawings.

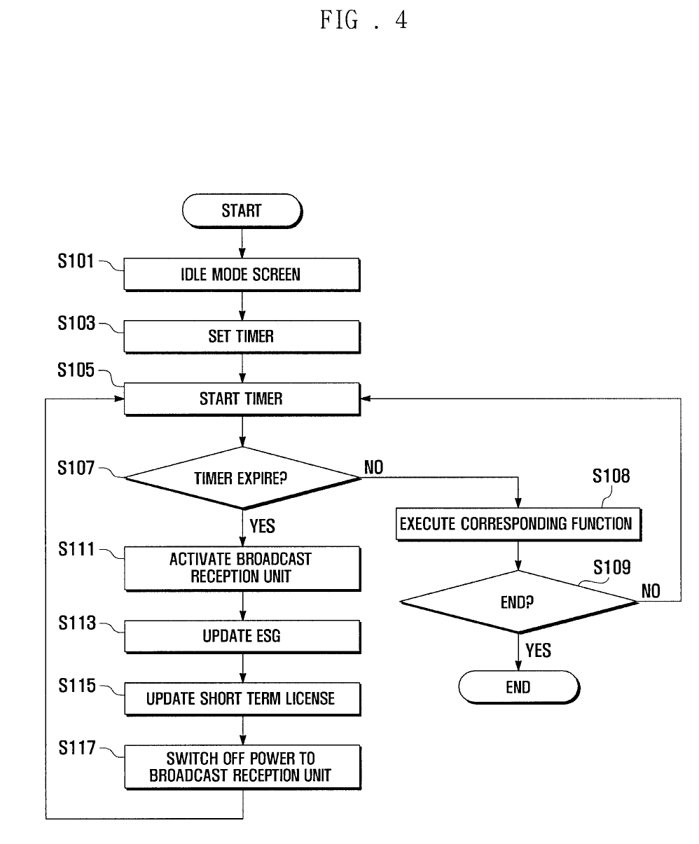

FIG. 4 is a flowchart illustrating a license update method for a right-protected broadcast channel according to an exemplary embodiment of the present invention.

Referring now to FIG. 4, once the digital broadcast receiver 10 powers on, the control unit 100 of the digital broadcast receiver 10 boots up and enters idle mode such that the digital broadcast receiver 10 displays a preset idle mode screen (101).

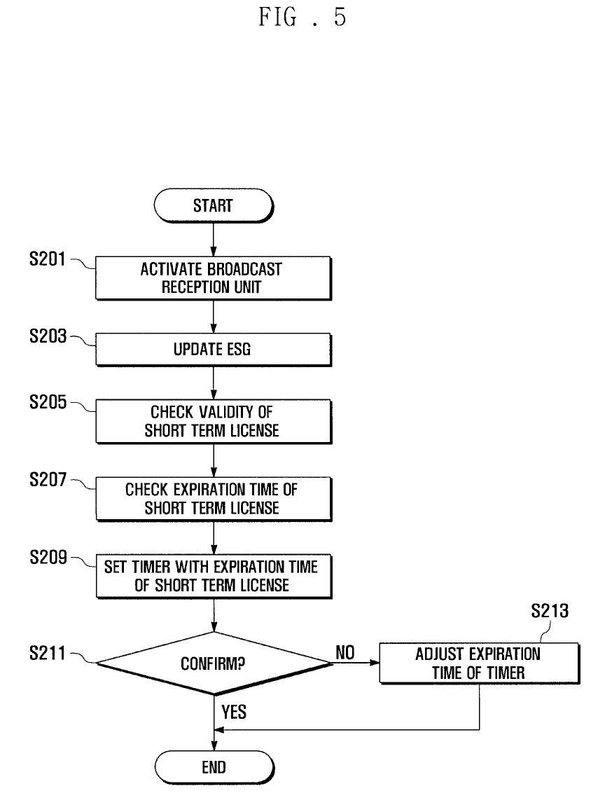

Next, the control unit 100 sets a timer to determine a license update timing for a right-protected broadcast channel in response to a user command (103). In more detail, when a user command requesting a license update timing setting is input, the control unit 100 causes a license update setting window to be displayed in the form of a popup window or a image window, whereby the user can set the license update timing by using the license update setting window. Here, it is preferred that the user may set a time point in a period during which the digital broadcast receiver 10 is likely to be in an idle mode, e.g. at dawn. Setting the license update timing can be done by using the short term license stored in the storage unit 150 previously as described with reference to FIG. 5. The timer can be set to expire just once or repeatedly after a given interval or at a specific time, e.g. a specific time of day, odd day of the month, even day of the month, or specific date, just to name a few possible examples.

After the timer has been set according to the user's intention, the control unit 100 starts the timer (105) and monitors to detect an event and, if any event is detected, determines whether the event is the expiration of the timer (107). If the event is not the expiration of the timer, the control unit 100 executes a function corresponding to the event, e.g. live broadcast playback, recorded file playback, and game functions (108). While the function is running, the control unit 100 preferably repeatedly checks whether or not a function termination command is input (109). If no function command is input, the process goes to step 107. At this point, it is preferred that the timer is running regardless of other functions of the digital broadcast receiver 10. That is, the timer is running regardless of other supplementary functions of the digital broadcast receiver 10 such that the control unit 100 receives an interrupt signal at the expiration of the timer.

If the expiration of the timer is detected at step 107, the control unit 100 activates the broadcast reception unit 160 (111). That is, the control unit 100 controls the power being supplied to the broadcast reception unit 160 and loads the application program for operating the broadcast reception unit 160 from the storage unit 150. Once the broadcast reception unit 160 is activated, the control unit 100 extracts the supplementary program information from the broadcast data received on the broadcast channel via the broadcast reception unit 160, extracting the ESG data from the supplementary program information, and updating the ESG data (113).

Next, the control unit 115 performs a short-term license update process (115). At this time, the control unit 100 checks the validity of the short-term license stored in the storage unit 150. If the short-term license is still valid, the control unit 100 skips updating the short-term license and restarts the timer. For instance, assuming the short-term license expires at 11:00 P.M. on August 30, the current time is 11:00 P.M. on August 30, and the timer is set to expire at 02:00 A.M. everyday; the control unit 100 waits until the timer expires, i.e. 02:00 on August 31, and updates the ESG and the short-term license at 02:00 on August 31. Also, assuming that the short term license expires at 10:00 P.M. on August 30, the current time is 08:00 A.M. on August 30, and the timer is set to expire at 10:00 A.M. everyday; the control unit 100 skips updating the short-term license at 10:00 A.M. on August 30 but updates the short term license at 10:00 A.M. on August 31. The update timing can be modified by the user. When the timer is set to expire at a specific time everyday, the control unit 100 controls such that the short term license is updated repeatedly at the expiration of the timer everyday.

At step 115, the control unit 100 activates the RF unit 110 to establish a communication channel with the broadcast server 13 and sends a short-term license update request message containing the device information of the digital broadcast receiver 10. Upon receipt of the short-term license update request message, the broadcast server 13 determines on the basis of the device information whether the update of the short-term license issued to the digital broadcast receiver 10 is required and, if required, sends a new short license to the digital broadcast receiver 10.

After updating the short-term license, the control unit 100 preferably switches off the power to the broadcast reception unit 160 to save energy (117). Next, the process returns to step 105.

As described in the above examples, the license update method for a right-protected broadcast channel according to the present invention operates the timer to determine the short-term license update timing regardless of the activation of the broadcast reception unit, whereby it is possible to update the short term license periodically and seamlessly. As a consequence, the license update method of the present invention can prevent the ongoing playback of the broadcast data on the right-protected channel from being interrupted due to the expiration of the short-term license without user's awareness. Furthermore, since the short-term license update is performed together with the update of the ESG data, the license update method improves the access time to the right-protected broadcast service using the recent ESG data. Also, a digital broadcast receiver can be configured to activate the broadcast reception unit at the expiration of the timer to update the short term license, skipping update of the ESG data.

FIG. 5 is a flowchart illustrating a timer setting process of the license update method according to an exemplary embodiment of the present invention.

Referring now to FIG. 5, at step (201) the control unit 100 first activates the broadcast reception unit 160 in response to a user command input through the input unit 120 such that the broadcast reception unit 160 starts receiving broadcast signal via the broadcast receiver 161.

Next at step (203), the broadcast reception unit 160 extracts the supplementary broadcast information from the broadcast signal, detects the ESG data from the supplementary broadcast information, and updates the ESG data stored in the storage unit 150 with the newly received ESG data (203).

At step (205), the control unit 100 checks the validity of the short-term license for a right-protected broadcast channel which is stored in the storage unit 150. At this time, the control unit activates the DRM engine, compares the expiration time of the short-term license with the current time to determine whether the expiration time of the short-term license is earlier than the current time.

Now at step (207), the control unit 100 monitors the expiration of the short term license.

Then at step (209) while monitoring the expiration of the short-term license, the control unit 100 sets a timer having an expiration time with reference to the expiration of the short term license. Here, the control unit 100 starts the timer and displays the expiration time of the short term license in the form a timer setting window together with the expiration time of the timer.

Next at step (211), the control unit 100 receives a user command input by the user through the timer setting window and determines whether the user command is a timer confirmation command. If the user command is a timer confirmation command, the control unit 100 completes setting the timer and at step (213) terminates the timer setting process. Otherwise, if the user command is a time adjustment command, the control unit 100 resets the expiration timer of the short term license base on the time information indicated by the time adjustment command and terminates the timer setting process. That is, the control unit 100 controls the display unit 140 to display the timer setting window showing the expiration time of the short-term license and the expiration time of the timer in the form of a popup window or an image window, such that the user can enter a new value for the expiration of the timer.

Although it is described that the control unit determines the expiration of the timer based on the time value input by the user in the timer setting process, the control unit can be configured to renew the expiration time of the timer with reference to the expiration of the short term license. Accordingly, the broadcast server can issue a new short-term license efficiently, thereby making it possible to reduce the unnecessary issuance of the short-term license and eliminate message exchanges between the digital broadcast receiver and the broadcast server.

As described above, the license update method and apparatus for a right-protected broadcast channel according to the present invention is advantageous to avoid the ongoing playback of the broadcast data on the right-protected broadcast channel from being interrupted due to the expiration of a periodic license without user's awareness.

Although exemplary embodiments of the present invention have been described in detail hereinabove, it should be clearly understood that many variations and/or modifications of the basic inventive concepts herein taught which may appear to those skilled in the present art will still fall within the spirit of the present invention, as defined in the scope of the appended claims.

What is claimed is:

1. A license update method for a digital broadcast receiver (DBR) having a right-protected broadcast channel, said method comprising:
setting a timer by a control unit;
detecting an expiration time of the timer; and
updating a short-term license having a periodic duration for the right-protected broadcast channel at the expiration time of the timer.

2. The license update method of claim 1, wherein the updating comprises entirely replacing the short-term license in the DBR with a new short-term license.

3. The license update method of claim 1, wherein the short-term license is updated with a periodicity within an entire duration of a long-term license.

4. The license update method of claim 1, wherein setting a timer comprises:
displaying a timer setting window;
receiving a time value input via the timer setting window; and
setting the expiration time of the timer with the time value.

5. The license update method of claim 1, wherein setting a timer comprises:
checking an expiration time of a short-term license which is stored previously; and
setting the expiration time of the short-term license as the expiration time of the timer.

6. The license update method of claim 1, wherein setting a timer comprises:
checking an expiration time of a short-term license which is stored previously;
displaying a timer reset window with the expiration time of the timer which is equal to the expiration time of the short-term license; and
resetting the expiration time of the timer according to a time value input via the timer reset window.

7. The license update method of claim 1, further comprising:
activating a broadcast reception unit at the expiration time of the timer for decoding broadcast data on the right-protected broadcast channel by using the short-term license; and
updating supplementary broadcast information stored previously by using the supplementary broadcast information extracted from a broadcast signal received from the broadcast reception unit.

8. The license update method of claim 1, wherein said detecting an expiration time of the timer is repeated periodically with each repeated initialization of the timer.

9. The license update method of claim 1, wherein updating a short-term license comprises replacing a previously stored license by:
sending device information of the digital broadcast receiver to a broadcast server;
issuing, at the broadcast server, a new short-term license based on the device information of the digital broadcast receiver, the new-short term license having the periodic duration starting from a time at which the device information is received by the broadcast server; and
sending the new short-term license from the broadcast server to the digital broadcast receiver.

10. A license update apparatus of a digital broadcast receiver for a right-protected broadcast channel, comprising:
a control unit for updating a short term license having a periodic duration updated with a periodicity within an entire duration of a long-term license for the right-protected broadcast channel at an expiration time of a timer;
a storage unit which under the control of the control unit stores an initial short-term license and stores an updated version of the short term license previously stored with a new short-term license;
a broadcast reception unit for decoding broadcast data on the right-protected broadcast channel by using the short-term license; and
a display unit which outputs the broadcast data decoded by the broadcast reception unit.

11. The license update apparatus of claim 10, wherein the storage unit comprises:
a timer setting window control routine which controls display of a timer setting window;
a timer operation routine which controls operation of the timer; and
a update control routine which controls update of the short-term license at the expiration time of the timer.

12. The license update apparatus of claim 11, wherein the timer setting window controls routine controls display of the timer setting window in response to a user command.

13. The license update apparatus of claim 10, wherein the storage unit comprises:
an expiration extraction routine which controls extraction of the expiration time of the short-term license; and
an expiration setting routine which sets the expiration time of the short-term license as the expiration time of the timer.

14. The license update apparatus of claim 13, wherein the storage unit comprises:
a timer reset window control routine which controls display of a timer reset window having the expiration time of the timer equal to the expiration time of the short term license; and
a timer reset routine which controls reset of the expiration time of the timer according to a timer value input by the timer reset window.

15. The license update apparatus of claim 10, wherein the control unit activates a broadcast reception unit at the expiration time of the timer and updates supplementary broadcast information stored previously by using the supplementary broadcast information extracted from a broadcast signal received by the broadcast reception unit.

16. The license update apparatus of claim 10, wherein the timer is repeatedly initialized and outputs an alarm signal to the control unit at the expiration time.

17. The license update apparatus of claim 10, further comprising a radio frequency unit which is activated to send device information of the digital broadcast receiver to a broadcast server and receive a new short term license issued based on the device information by the broadcast server under the control of the control unit.

18. The license update apparatus of claim 10, wherein the short-term license specifies the periodic duration starting from a time at which the device information is received by the broadcast server.

19. The license update apparatus of claim 10, wherein the broadcast reception unit comprises:
a broadcast receiver for receiving broadcast data on selected broadcast channels under the control of the control unit;
a protocol processor for performing protocol processing of the broadcast data of the broadcast channels so as to extract video data, audio data, and supplementary broadcast information; and
a decoder including an audio decoder, a video decoder, and a data processor.

20. The license update apparatus of claim 19, wherein:
the audio decoder decodes the audio data extracted from the broadcast data; and
the video decoder decodes the video data extracted from the broadcast data; and
the data processor decodes the supplementary broadcast information and optionally updates the supplementary broadcast information.
